(19) United States
(12) Patent Application Publication
(10) Pub. No.: US 2008/0033071 A1
(43) Pub. Date: Feb. 7, 2008

(54) Use of Light-Activated Hardenable Silicon Compositions for the Production of Thick-Walled Moulded Articles or Thick-Walled Coatings

(75) Inventors: Uwe Irmer, Leichlingen (DE); Stefan Rist, Leverkusen (DE); Stephan Bosshammer, Koln (DE); Markus Putzer, Leverkusen (DE); Thomas Naumann, Leverkusen (DE)

Correspondence Address: RANKIN, HILL, PORTER & CLARK, LLP, 925 EUCLID AVENUE, SUITE 700, CLEVELAND, OH, 44115-1405, US

(73) Assignee: GE Bayer Silicones GmbH & Co. KG, Leverkusen (DE)

(21) Appl. No.: 11/572,592

(22) PCT Filed: Jul. 27, 2005
(86) PCT No.: PCT/EP05/53653

§ 371 Date: Apr. 25, 2007

(30) Foreign Application Priority Data
Jul. 28, 2004 (DE) 102004036573.3

(51) Int. Cl. C08K 5/56; C08L 83/04

(52) U.S. Cl. 522/66; 522/99

(57) ABSTRACT

The invention relates to the use of light-activated hardenable silicon compositions for the production of thick-walled moulded articles or thick-walled coatings, such as moulds for casting compositions, moulding compositions, sealants, prosthetic moulded articles or casts, formed-in-place gaskets, thick-walled coatings such as conformal coatings and method for production thereof.

The present invention relates to the use of light-activatable, curable or crosslinkable silicone compositions for production of thick-walled molding products or of thick-walled coatings, examples being forms for casting compositions, potting compositions, or of sealants, of prosthetic molding products, or impressions, or of formed-in-place gaskets, or of thick-walled coatings, such as conformal coatings, and to processes for their production.

Thick-walled molding products or coatings can be composed of thermoplastic, thermoset, or elastomeric materials, these being prepared from the appropriate curable molding compositions or rubbers after forming with exposure to heat or crosslinking of reactive resins or rubber mixtures in a shaping process. When heat is used in the shaping process or crosslinking, shrinkage effects are observed and inhibit dimensionally accurate molding. The shrinkage leads not only to lack of dimensional accuracy but also to demolding problems when the molding products are removed from the mold, or to break-away from the article to be sealed, examples being raceway seals, and articles for embedding, e.g. electronic circuits, cable plugs, etc. Large-volume or thick-walled parts whose wall thicknesses are more than 10 mm or whose volume is more than 1 liter, such as insulators, pose a particular problem, because shrinkage effects are particularly marked here and there is no guarantee that thermal curing in depth will occur in a short period when fillers and pigments are also present. Curing at the service temperature of the molding or of the coating is therefore desirable, in order to minimize any shrinkage effect due to thermal expansion. The curing temperature here should therefore usually be the ambient temperature of from 0 to 50° C. This means that the curing of such molding products or coatings is preferably brought about by addition reactions, i.e. by crosslinking mechanisms which do not bring about any loss in weight during curing.

A further intention is that the temperature needed for curing of the molding composition be no more than slightly above the ambient temperature.

If the intention is to produce thick-walled molding products and coatings from silicone molding compositions, i.e. from silicone resins or from silicone rubbers, it is in principle possible to resort to the reactions of free-radical crosslinking, addition crosslinking, condensation crosslinking, or various types of photo-crosslinking. Types of crosslinking which do not need any additional heating comprise condensation crosslinking, addition crosslinking, and photo-crosslinking.

Because condensates involve loss in weight, addition reactions and photo-reactions will advantageously be studied in more detail for achievement of the object.

The addition reaction, controlled via inhibitors, in which a hydrosilylation reaction leads to crosslinking of the molding compositions needs an inhibitor in order to guarantee a certain processing time for the reactive composition. However, that necessitates longer crosslinking times or heating. If the inhibitor is omitted, although short crosslinking times are obtained, short processing times equally have to be accepted for the reactive, crosslinkable molding compositions.

It is therefore usually impossible to decouple the crosslinking time from the processing time prior to the start of crosslinking.

Among the various available types of photo-activated crosslinking, there are systems which demand complicated, organofunctional polymer systems. However, among these there are also systems which in essence are composed of relatively readily available polyalkenylalkylsiloxanes and polyhydroalkylsiloxanes.

The use of known silicone molding compositions which can be cured via light-activation has hitherto been subject to limits when these are employed for production of thick-walled, large-volume molding compositions which also have pigmentation, and the intention has been to cure these in a short time, or an additional demand has been that the regions not exposed to light, i.e. shadow regions, be likewise hardened.

No compositions or processes have been proposed for realizing thick-walled, large-volume molding products and coatings by this route, in particular when these are intended to comprise further fillers and are intended to be equal to specific requirements in relation to mechanical strength or in relation to strength in the face of damaging high-tension loads. However, these requirements have to be met by molding products such as thick-walled, large-volume insulators or coatings.

Combinations of various crosslinking reactions have been disclosed and claimed in the prior art in order to solve the problem. By way of example, U.S. Pat. No. 4,699,802 describes crosslinking of polydihydrocarbylsiloxane prepolymer with acrylate or methacrylate groups in conjunction with a free-radical photoinitiator. Crosslinking of the polymer takes place here in the zones exposed to UV light. In the zones not exposed to light, curing by means of atmospheric moisture brings about crosslinking. Disadvantages here are the long post-curing time as a consequence of the slow diffusion of atmospheric moisture to the zones not exposed to light, the loss in weight via products of condensation or of cleavage, and also the need for use of siloxane-acrylate copolymers requiring complicated preparation restrict availability and cost-effectiveness. Furthermore, this process cannot be used when access of atmospheric moisture into the regions exposed, and not exposed, to light is not possible after a sealed component has been exposed to UV light.

In contrast, EP 0146307 A1 discloses a very simple addition system, using a photo-activated platinum complex selected from complexes with eta-cyclopentadienyl- and 3 sigma-bonded aliphatic substituents to produce release coatings (release papers) layers lying in the micrometer range. Said document does not disclose how thick-walled filled and/or pigmented molding products or coatings can be produced. A particular reason for the problems of using simple casting or layer-application to produce thick-walled molding products or coatings where the thickness of the layers is some millimeters and, respectively, where good mechanical properties are present is that these generally demand addition of thickening or reinforcing fillers. Fillers in turn can drastically reduce transparency as a function of the thickness of the layer, and thus can inhibit ingress of light into deep layers. It was therefore in particular impossible according to the process described in EP 0146307 to produce pigmented or highly filled thick-walled molding products or coatings with high strength. The person skilled in the art would moreover have expected to need extremely large amounts of platinum for curing of thick-walled molding products or coatings, in order to arrive at sufficiently rapid and complete crosslinking. It is therefore not obvious to the person skilled in the art to use the light-curable compositions of EP 0146307 for production of thick-walled molding products or coatings, even if no mention is made of pigmented, opaque or translucent molding products or coatings.

EP 358 452 A therefore suggests the route of producing thick-walled molding products, such as dental impression compositions, with the aid of additional photosensitizers. U.S. Pat. No. 6,376,569 B1 (EP 561 893 B1), U.S. Pat. No. 6,046,250 A (EP 561 919 B1), or WO 92-10544 A1 (EP 561 923 A1) disclose similar silicone molding compositions, these being prepared with use of additional photosensitizers. However, this process is disadvantageous, since the use of the additional photosensitizers can have environmental and economic disadvantages.

EP 832 936 discloses light-curable, liquid silicone rubber compositions for production of a master mold which in turn serves for molding of a light-curable liquid resin. The light transmittance of the cured product has to be at least 10% for light whose wavelength is from 200 to 500 nm, measured at 10 mm thickness, since otherwise the light transmittance is too low for curing of the light-curable liquid resins of the replicate. In EP 832 936 the inventors aimed from the very start at production of light-permeable master molds, so the problem of production of low-transparency, in particular filled and, respectively, pigmented thick-walled moldings did not arise there. EP 832 936 omits use of a reinforcing, i.e. opacifying, filler (e.g. in particular certain silicas), with the aim of maximizing completeness of curing of the light-curable silicone composition, and instead of this uses a silicone resin with M and Q units, in order to provide sufficient light transmittance and hardness of the parent molds. These compositions cannot therefore be used to produce any desired thick-walled, if appropriate pigmented, molding products or coatings.

Surprisingly, it has been found to be possible to use light-activatable, curing siloxane compositions in particular without addition of photosensitizers for production of thick-walled, in particular filled and/or pigmented molding products and coatings of low transparency, in particular when certain processes are used. Surprisingly, it is thus possible to utilize the advantages of use of light-curable and, respectively, light-activatable siloxane compositions, e.g. lower shrinkage, high arc resistance and high tracking resistance, and also good mechanical properties, even when thick-walled, in particular filled and/or pigmented, molding products are produced.

The present invention therefore provides the use of a light-activatable, curable siloxane composition, comprising:
a) at least one polyorganosiloxane having an average of at least two unsaturated organic groups per molecule,
b) at least one polyhydroorganosiloxane having an average of at least two SiH groups per molecule,
c) if appropriate, one or more fillers,
d) at least one photo-activatable catalyst, comprising a metal selected from the group consisting of Pt, Ru, Rh, Pd, Ir or Ni, or a compound of the metal mentioned,
e) if appropriate, one or more auxiliaries,
   for production of thick-walled molding products or of thick-walled coatings.
   Component a) (Si-alkenyl)

The viscosity range of the polyorganosiloxane (a) containing alkenyl groups in the light-activatable, curable siloxane compositions used according to the invention is preferably from 0.025 to 500 Pa·s, preferably from 0.1 to 100 Pa·s (25° C.; shear gradient D of 1 s⁻¹). It can be composed of a unitary polymer or of a mixture of various polyorganosiloxanes, e.g. various polymers (a1) which are in essence linear having low alkenyl content, or a mixture composed of the polymers (a1) which are in essence linear and of preferably branched polymers (a2) having relatively high alkenyl content, these being as described in further detail at a later stage below.

The polyorganosiloxane (a) is preferably composed at least of the siloxane units which are selected from the group composed of the units M=R¹R₂SiO_{1/2}, D=R¹SiO_{2/2}, T=R¹SiO_{3/2}, Q=SiO_{4/2}, and also of the divalent units R², in which R, R¹ and R² are defined as below.

According to the invention, the polyorganosiloxanes (a) can in principle be selected from two groups (a1) and (a2).

The group (a1) is the group of the polyorganosiloxanes having low alkenyl group content of from about 0.002 to about 3.0 mmol/g, more preferably from 0.004 to 1.5 mmol/g. These polyorganosiloxanes are generally in essence linear.

The group (a2) is the group of the polyorganosiloxanes whose content of alkenyl groups is high, from about 3.0 to about 22 mmol/g. These can include both linear and branched polyorganosiloxanes.

The polyorganosiloxanes (a) are preferably prepared via catalytic equilibration or catalyzed polycondensation, as disclosed in U.S. Pat. No. 6,387,487, columns 3 and 4.

The polyorganosiloxanes (a) can be described by the general formula (I):
[Mₐ₁D_{b1}T_{c1}Q_{d1}R²ₑ₁]ₘ₁ (I)
in which
M=R¹R₂SiO_{1/2},
D=R¹RSiO_{2/2},
T=R¹SiO_{3/2},
Q=SiO_{4/2},
   where
m1=1-1000
a1=1-10
b1=0-3000
c1=0-50
d1=0-1
e1=0-300,
   in which
R=an organic group, preferably unsubstituted or substituted hydrocarbon radicals, more preferably n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R can have substitution by one or more F atoms and/or can contain one or more —O— groups.

Examples of suitable monovalent hydrocarbon radicals R include alkyl groups, preferably CH₃, CH₃CH₂, (CH₃)₂CH, C₈H₁₇ and C₁₀H₂₁ groups, cycloaliphatic group such as cyclohexylethyl, aryl groups, such as phenyl, tolyl, xylyl, aralkyl groups, such as benzyl and 2-phenylethyl groups. Preferred monovalent halogenated hydrocarbon radicals R in particular have the formula CₙF₂ₙ₊₁CH₂CH₂—, where n is from 1 to 10, examples being CF₃CH₂CH₂—, C₄F₉CH₂CH₂—, and C₆F₁₃CH₂CH₂—. A preferred radical is the 3,3,3-trifluoropropyl group.

Particularly preferred radicals R include methyl, phenyl, and 3,3,3-trifluoropropyl

R¹═R or an unsubstituted or substituted C₂-C₁₂-alkenyl radical, with the proviso that at least two radicals R₁ are an alkenyl-containing organic group, these preferably being selected from: unsubstituted and substituted alkenyl-containing hydrocarbon radicals, such as n-, iso-, tert-, or cyclic C₂-C₁₂-alkenyl, vinyl, allyl, hexenyl, C₆-C₃₀-cycloalkenyl, cycloalkenylalkyl, norbornenylethyl, limonenyl, C₈-C₃₀-alkenylaryl, in which, if appropriate, one or more —O— atoms can be present (corresponding to ether radicals) and the radicals can have substitution by one or more F atoms.

Preferred radicals R¹ are groups such as vinyl, allyl, 5-hexenyl, cyclohexenylethyl, limonenyl, norbornenylethyl, ethylidenenorbornyl, and styryl, particular preference being given to vinyl.

R²=a divalent aliphatic n-, iso-, tert-, or cyclic C₁-C₁₄-alkylene radical, or a C₆-C₁₄-arylene or, respectively, alkylenearyl radical, which in each case bridges two siloxy units M, D or T, an example being -D-R²-D—. R² here is preferably selected from divalent aliphatic or aromatic n-, iso-, tert-, or cyclic C₁-C₁₄-alkylene, C₆-C₁₄-arylene, or -alkylenearyl groups.

Examples of suitable divalent hydrocarbon groups R² which can bridge siloxy units include all of the alkylene and dialkylarylene radicals, preferably those such as —CH₂—, —CH₂CH₂—, CH₂(CH₃)CH—, —(CH₂)₄, —CH₂CH(CH₃)CH₂—, —(CH₂)₆— —(CH₂)₈—, and —(CH₂)₁₈-cycloalkylene groups, such as cyclohexylene, arylene groups, such as phenylene, xylene. Their proportion does not generally exceed 30 mol % of all the siloxy units. Preference is given to groups such as alpha,omega-ethylene, alpha,omega-hexylene, or alpha,omega-phenylene.

In these, the siloxy units M, D, T and Q can have linkage to one another and distribution in the polymer chain in a blockwise or random manner. Within the polysiloxane chain, each siloxane unit can be identical or different.

The indices are average degrees of polymerization. The indices are preferably as follows, and are advantageously selected as a function of the viscosity desired.

The abovementioned polyorganosiloxanes (a1) preferably have a structure of the general formula (Ia), preferably of the formula (Ia′),
R¹R₂SiO(R¹RSiO)_{b1}SiR₂R¹ (Ia),
R¹R₂SiO(R₂SiO)_{b1}SiR₂R¹ (Ia′)
in which R and R¹ are defined as above and b1<3000.

The polyorganosiloxanes (a1) of the formulae (Ia) and (Ia′) are substantially linear and their content of unsaturated organic groups is preferably from 0.002 to 3 mmol/g, more preferably from 0.004 to 1.5 mmol/g. The content of unsaturated groups here is based on polymethylvinylsiloxane and, within the prescribed viscosity limits, is to be appropriately adjusted on the basis of siloxy groups using other substituents with other molecular weights.

The expression “substantially linear” for the polyorganosiloxane (a1) preferably encompasses those polyorganosiloxanes which preferably contain no more than 0.1 mol % of siloxane units selected from T=RSiO_{3/2} or Q=SiO_{4/2}.

Examples of preferred siloxy units in the polyorganosiloxanes (a) are alkenylsiloxy units, such as dimethylvinylsiloxy units, alkylsiloxy units, such as trimethylsiloxy units, dimethylsiloxy units, and methylsiloxy units, arylsiloxy units, such as phenylsiloxy units, such as triphenylsiloxy-dimethylphenylsiloxy units, diphenylsiloxy units, phenylmethylvinylsiloxy units, phenylmethylsiloxy units.

In the polyorganosiloxanes (a1) mentioned, it is preferable that at least 90 mol % (preferably from 90 to 99.99 mol %, based on Si atoms) of the radicals R are methyl radicals.

The alkenyl groups can have been bonded either at the chain end of a siloxane molecule or as substituent on a silicon atom in a siloxane chain.

In the case of low-alkenyl-content polyorganosiloxanes (a1) which are in essence linear it is preferable that the alkenyl groups are present only at the chain end of the siloxane molecule. When alkenyl groups are present on the inner silicon atoms of the siloxane chains, their content in the low-alkenyl-content polyorganosiloxanes (a1) is therefore preferably smaller than 0.01 mmol/g and, respectively, smaller than 0.0074 mol %, based on siloxane units.

In order to improve mechanical properties, such as tear propagation resistance, of the crosslinked products, it is advantageous to use blends of various polymers (i.e. at least two polymers (a1) or at least one polymer (a1) and (a2) being present) with different alkenyl content and/or with different chain length, where the entire content of unsaturated groups advantageously does not exceed 3.0 mmol/g in component (a), based on vinyl-containing polydimethylsiloxanes.

By way of example, it is possible to use mixtures of polyorganosiloxanes (a1) and (a2) in mixing ratios of
from 60 to 100% by weight of (a1) and
from 0 to 40% by weight of (a2).

The viscosity both of the polyorganosiloxane (a1) and of the mixture composed of (a1) and (a2) is preferably from 0.025 to 500 Pa·s, very particularly preferably from 0.2 to 100 Pa·s, at 25° C. Viscosity is measured to DIN 53019 at 25° C. with a shear gradient D=1 s⁻¹.

It is preferable that the number of siloxy units in the polyorganosiloxane (a1) is from 20 to 3000, particularly from 100 to 1500 (average degree of polymerization of Pₙ, which is based on polymethylvinylsiloxane and, within the prescribed viscosity limits, is to be appropriately adjusted on the basis of siloxy groups using other substituents with other molecular weights.)

Alkenyl content is determined here by way of ¹H NMR—see A. L. Smith (ed.): The Analytical Chemistry of Silicones, J. Wiley & Sons 1991 Vol. 112 pp. 356 et seq. in Chemical Analysis ed. by J. D. Winefordner.

Another class of preferred polymers (a), which can, together with (a1), form component (a) is that of high-vinyl-content, if appropriate branched polyorganosiloxanes (a2), which can be used to raise, for example, tear propagation resistance or tensile strength in combination with further polyorganosiloxanes, such as those defined above.

These branched high-alkenyl-content polyorganosiloxanes (a2) have been disclosed by way of example in U.S. Pat. No. 3 284 406, U.S. Pat. No. 3,699,073, and contain an increased proportion of unsaturated radicals R′, and can, unlike the linear polyorganosiloxanes, have an increased proportion of branched or branching siloxane units T=RSiO_{3/2} or Q=SiO_{4/2}, the amount of these present in one embodiment being more than 0.1 mol %, based on the Si atoms present. However, the amount of branching units is intended to be limited by the fact that this component is intended to give silicone compositions which are preferably liquid, melt at low temperature (freezing point<160° C.), or which are miscible with the remaining polymers (a1) and are transparent (>70% transmittance at 400 nm, thickness of layer: 2 mm).

The abovementioned, branched polyorganosiloxanes (a2) are polymers which contain the abovementioned M, D, T, and Q units. They preferably have the general stoichiometric formulae (II), (IIa) to (IIb):
[Mₐ₂D_{b2}T_{c2}Q_{d2}]ₘ₂ (II)
{[R₁SiO_{3/2}][R⁴O_{1/2}]ₙ₁}ₘ₂ (IIa)
{[SiO_{4/2}}][R⁴O_{1/2}]ₙ₁[R₂R¹SiO_{1/2}]0.01-10[RSiO_{3/2}]₀₋₅₀[R₂SiO_{2/2}]₀₋₅₀₀}ₘ₂ (IIb)
in which R⁴ is an organic radical, such as C₁ to C₂₂-alkyl, aryl, or arylalkyl.

The radical R⁴O_{1/2} is preferably methoxy, ethoxy, or hydroxyl, with the preferred indices

m2=from 1 to 100

n1=from 0.001 to 4

a2=from 0.01 to 10

b2=from 0 to 10

c2=from 0 to 50

d2=1.

The values that can be assumed by the molar ratio M:Q are from 0.1 to 4:1, and respectively from 0.1 to 3:1 for M:T, the D:Q and, respectively, D:T ratio being from 0 to 333:1, where the M, D and T units here can contain the radicals R or R¹.

Polyorganosiloxanes (a2) having a high content of alkenyl groups include in particular liquid polyorganosiloxanes, organic-solvent-soluble solid resins or liquid resins, these preferably being composed of trialkylsiloxy (M units) and silicate units (Q units), and preferably comprising an amount of at least 3 mmol/g of vinyldimethyl-siloxy units. These resins can moreover also have, on the Si atoms, up to at most 10 mol % of alkoxy groups or of OH groups.

In another preferred embodiment, the polyorganosiloxanes (a2) have the general formula (Ia), with the proviso that they have increased vinyl content as defined under (a2).

In the abovementioned branched polyorganosiloxanes (a2), at least 50 mol % (i.e. from 50 to 95 mol %, based on Si atoms), preferably at least 80 mol %, of the radicals R preferably take the form of methyl radicals. The content of alkenyl groups in the polyorganosiloxane (a2) having high content of alkenyl groups and preferably high content of vinyl groups is preferably more than 3 mmol/g to about 22 mol/g. The content here is based on polymethylvinylsiloxanes and, within the prescribed viscosity limits, is to be appropriately adjusted on the basis of siloxy groups using other substituents on the silicon atom with other molecular weights.

In one preferred embodiment of the invention, the polyorganosiloxane (a) in essence encompasses low-vinyl-content, linear polyorganosiloxanes (a1), as described above. High-vinyl-content polyorganosiloxanes (a2), as described above, can be added in order to improve mechanical properties, in particular when there is a limit on the amount of the filler, for example for reasons of viscosity.

A further preferred mixture of the polyorganosiloxanes (a) comprises at least two polyorganosiloxanes (a1) which in essence are linear and are alkenyl-end-capped, having different alkenyl contents, preferably vinyl contents. The intention of this measure is firstly to prescribe minimum viscosity for the silicone composition and secondly to permit a crosslinking structure, using the Si—H bonds defined below of component (b), these bringing about a maximum level of mechanical properties, such as tensile strain and tear propagation resistance, of the crosslinked silicone rubbers. When relatively large amounts of short-chain alpha,omega-siloxanes are used (advantageously at viscosity below 10 Pa·s), the result is a requirement for relatively large amounts of alpha,omega-Si—H siloxanes as what are known as chain extenders, in order to form suitable crosslinking structures.

A containing alkenyl groups and not composed of a mixture of a poly-diorganosiloxane of type (a) is defined by the fact that the distribution of the weight- and number-average has derived from one of the known polymerization reactions, preferably from equilibration or polycondensation using basic or acidic catalysts. Processes of this type using alkaline or acidic catalysts are disclosed by way of example in U.S. Pat. No. 5,536,803, column 4. The Mw/Mn ratio of polyorganosiloxanes equilibrated by this process is usually from 1 to 10, preferably 1-2, ignoring the fractions whose molar mass is smaller than 500 g/mol, for the case R=methyl and R¹=vinyl.

The polymerization reaction using basic or acidic catalysts can use both the various cyclosiloxanes, and linear polyorganosiloxanes, and also symmetrical 1,3-divinyltetramethyldisiloxane, and other relatively long-chain siloxanes having a trialkylsiloxy end cap or OH end groups. Examples of those used for this purpose are the hydrolysates of different alkylchlorosilanes, e.g. vinyldimethylchlorosilane and/or dimethyldichlorosilane, other examples being the trialkyl-terminated siloxanes per se obtained therefrom or these in a mixture with other siloxanes.

The average degree of polymerization Pₙ of the polyorganosiloxanes (a), measured as number average Mₙ by GPC and using polystyrene as standard is preferably in the range Pₙ> from 20 to 3000, the more preferred range being Pₙ from 200 to 1500.

The polymers (a) thus defined permit, in combination with suitable polyhydroorganosiloxanes described below for component (b), production of molding products or of impression compositions which have sufficiently good vulcanizate properties, such as tensile strain at break, tensile strain and tear propagation resistance, and also stability of mechanical properties.

Component b) (Si—H-containing polysiloxanes)

The polyorganohydrosiloxanes (b) are preferably selected from linear, cyclic or branched SiH-containing polyorganosiloxanes of the general formula (II):
[Mₐ₄D_{b4}T_{c4}Q_{d4}R²ₑ₂]ₘ₃ (II)
in which

M=R³R₂SiO_{1/2},

D=R³RSiO_{2/2},

T=R³SiO_{3/2},

Q=SiO_{4/2}, in which

R=n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl, each of these radicals R can have substitution by one or more F atoms and/or can contain one or more —O— groups,

R³═R or hydrogen, with the proviso that at least two radicals R³ per molecule are hydrogen, and both here can occur simultaneously in one molecule, but at least two radicals R³ per molecule are hydrogen, R being defined above, R=methyl being preferred.

R²=a divalent aliphatic n-, iso-, tert-₃ or cyclic C₁-c₁₄-alkylene radical, or a C₆-C₁₄-arylene or, respectively, alkylenearyl radical, which in each case bridges two siloxy units M, D or T,
m3=from 1 to 1000
a4=from 1 to 10
b4=from 0 to 1000
c4=from 0 to 50
d4=from 0 to 1
e2=from 0 to 300.

The polyorganohydrosiloxanes (b) are preferably linear, cyclic, or branched polyorganosiloxanes whose siloxy units have advantageously been selected from M=R₃SiO_{1/2}, M^{H}=R₂HSiO_{1/2}, D^{H}=R₂SiO_{2/2}, D^{H}=RHSiO_{2/2}, T=RSiO_{3/2}, T=HSiO_{3/2}, Q=SiO_{4/2} in which these units are preferably selected from MeHSiO units and Me₂HSiO_{0.5} units alongside, if appropriate, other organosiloxy units, preferably dimethylsiloxy units.

The siloxy units can be present with linkage to one another in the polymer chain, blockwise or randomly. Each siloxane unit of the polysiloxane chain can bear identical or different radicals.

The indices of the formula (III) describe the average degree of polymerization Pn, measured as number average Mn, determined by GPC (polystyrene as standard) these being based on polyhydromethylsiloxane and, within the prescribed viscosity limits, is to be appropriately adjusted on the basis of siloxy groups using other substituents with other molecular weights.

The polyorganohydrosiloxane (b) in particular encompasses all of the liquid, flowable, and solid polymer structures of the formula (III) with the degrees of polymerization resulting from the indices stated above. Preference is given to the polyorganohydrosiloxanes (b) which are liquid at 25° C. and whose molar mass is low, i.e. smaller than about 60 000 g/mol, preferably smaller than 20 000 g/mol.

The preferred polyorganohydrosiloxanes (b) are structures which are selected from the group which can be described via the formulae (IIa-IIIe)
HR₂SiO(R₂SiO)_{z}(RHSiO)ₚSiR₂H (IIIa)
HMe₂SiO(Me₂SiO)_{z}(MeHSiO)ₚSiMe₂H (IIIb)
Me₃SiO(Me₂SiO)_{z}(MeHSiO)ₚSiMe₃ (IIIc)
Me₃SiO(MeHSiO)ₚSiMe₃ (IIId)
{[R₂R³SiO_{1/2}]₀₋₃[R³SiO_{3/2}][R⁴O)ₙ₂}ₘ₃ (IIIe)
{[SiO_{4/2}}][R⁴O_{1/2}]ₙ₂[R₂R³SiO_{1/2}]_{0.01-10}[R³SiO_{3/2}]₀₋₅₀[RR³SiO_{2/2}]₀₋₁₀₀₀}ₘ₃ (IIIf)
where

z=from 0 to 1000

p=from 0 to 100

z+p=b4=from 1 to 1000

n2=from 0.001 to 4

in which R⁴O_{1/2} is an alkoxy radical on silicon, and

R³ is defined as above.

One preferred embodiment of the class (IIIe) and (IIIf) compound is provided by way of example by monomeric to polymeric compounds which can be described via the formula [(Me₂HSiO)₄Si]ₘ₃. The concentration of SiH is preferably in the range from 0.1 to 17 mmol/g, which is based on polyhydromethylsiloxanes and, within the prescribed viscosity limits, is to be appropriately adjusted on the basis of siloxy groups using other substituents.

In one particularly preferred selection of the formula (IIIb) where R=methyl and z>0, the SiH concentration in the polymeric crosslinking agents has a preferred value of from 0.05 to 12 mmol of SiH/g. If z=0, as in formula (IIIc) where R=methyl, concentration of SiH is preferably 7-17 mmol of SiH/g.

In one preferred embodiment of the invention, the polyorganohydrosiloxane (b) is composed of at least one polyorganohydrosiloxane (b1) having two Si—H groups per molecule and of at least one polyorganohydrosiloxane of type (b2) having more than two Si—H groups per molecule. In this embodiment, component (b) is composed of at least two different organohydropolysiloxanes, which produce different crosslinking structures, in order to give high-strength silicone elastomers in combination with low-viscosity polysiloxanes of component (a). Two functions can in essence be attributed to these different organohydropolysiloxanes. Bifunctional polyorganohydrosiloxanes (b1) act as what are known as chain extenders, and the polyorganohydrosiloxanes (b2) of relatively high functionality (>2) act as crosslinking agents. The silicone composition used according to the invention preferably comprises at least one bifunctional chain extender (b1) and at least one crosslinking agent (b2).

Examples of preferred structures of component (b1) in the inventive silicone rubber composition include chain extenders (b1) such as:

HMe₂SiO—(Me₂SiO)_{z}SiMe₂H, and

Me₃SiO—(Me₂SiO)_{z}(MeHSiO₂)SiMe₃

[(Me₂SiO)_{z}(MeHSiO₂].

The crosslinking agents (b2) comprise compounds such as:

Me₃SiO—(MeHSiO)ₚSiMe₃,

HMe₂SiO(Me₂SiO)_{z}(MePhSiO)_{z}(MeHSiO)ₚSiMe₂H,

(MeHSiO)ₚ,

(HMe₂SiO)₄Si

MeSi(OSiMe₂H)₃,

in which p and z are defined as above.

Mixtures of this type composed of what are known as chain extenders and crosslinking agents can be used by way of example as described in U.S. Pat. No. 3,697,473.

In a further preferred embodiment, the amount of components (b1) and (b2) is
from 0 to 70 mol % of (b1), and
from 30 to 100 mol % of (b2), based on (b1) and (b2).

If it is necessary to increase the crosslinking rate, this can by way of example be achieved via an increase of the ratio of SiH to alkenyl, or an increased amount of catalyst (d), or an increase in the proportion of polyorganosiloxanes (b2) which contain HMe₂SiO_{0.5} units.

The polyorganosiloxanes (b) are preferably siloxane-soluble and, respectively, liquid at room temperature, i.e. preferably have fewer than 1000 siloxy units, i.e. preferably have viscosities below 40 Pa·s at 25° C. and D=1 s⁻¹.

The chain length of the crosslinking agents as component (b2), which are mainly composed of MeHSiO units, is preferably from 3 to 200, particularly preferably being from 15 to 60 MeHSiO units.

The chain length of the chain extenders as component (b1), these being mainly composed of Me₂SiO units and HMe₂SiO_{1/2}, is preferably from 2 to 100, particularly preferably being from 2 to 60 Me₂SiO units.

SiH content in the present invention is determined by way of ¹H NMR, see A. L. Smith (ed.): The Analytical Chemistry of Silicones, J. Wiley & Sons 1991 Vol. 112 pp. 356 et seq. in Chemical Analysis ed. by J. D. Winefordner.

The polyorganohydrosiloxanes (b) can be prepared by processes known per se, e.g. using acidic equilibration or condensation, as disclosed by way of example in U.S. Pat. No. 5,536,803. The polyorganohydrosiloxanes (b) can also be reaction products which have come from hydrosilylation of organohydrosiloxanes using siloxanes containing alkenyl groups in the presence of the catalysts (c), where the resultant SiH content is preferably within the limits defined above. This gives organohydrosiloxanes (b) bridged by alkylene groups or by R².

The polyorganohydrosiloxanes (b) can moreover also be reaction products which have come from condensation of, for example, organohydroalkoxysiloxanes (b) using hydroxy- or alkoxysilanes and, respectively, siloxanes, e.g. as described in U.S. Pat. No. 4,082,726, e.g. columns 5 and 6.

According to the invention, it is preferable to select the ratio of component (b) to component (a) in such a way that the molar ratio present of Si—H to Si-alkenyl units is from about 0.5 to 20:1, preferably from 1 to 3:1.

The preferred amount of the polyorganohydrosiloxanes (b) is from 0.1 to 200 parts by weight, based on 100 parts by weight of component (a).

Many properties, such as vulcanizate properties, crosslinking rate, stability, and surface tack, can be influenced by way of the ratio of SiH units to Si-alkenyl units.

Component c) (filler)

The silicone rubber mixtures used according to the invention moreover optionally comprise one or more, if appropriate surface-modified, fillers (c).

These include by way of example all of the fine-particle fillers, i.e. those having particles smaller than 100 μm, i.e. preferably composed of such particles. These can be mineral fillers, such as silicates, carbonates, nitrides, oxides, carbon blacks, or silicas. The fillers are preferably those known as reinforcing silicas, which permit production of opaque elastomers having better transparency, i.e. those which improve vulcanizate properties after crosslinking, and increase strength, examples being fumed or precipitated silica whose BET surface areas are from 50 to 400 m²/g, these preferably having been specifically surface-hydrophobicized here. If component (c) is used, its amounts are from 1 to 100 parts by weight, preferably from 10 to 70 parts by weight, even more preferably from 10 to 50 parts by weight, based on 100 parts by weight of component (a).

Fillers whose BET surface areas are above 50 m²/g permit production of silicone elastomers with improved vulcanizate properties. It is only above 90 m²/g that vulcanizate strength and transparency increase with, for example, fumed silicas, and these are therefore preferred, and even more preferred silicas are, for example, Aerosil 200, 300, HDK N20 or T30, Cab-O-Sil MS 7 or HS 5 more than 200 m²/g BET surface area As BET surface area rises, the transparency of the silicone mixtures in which these materials are present also rises. Examples of trade names of the materials known as precipitated silicas, or wet silicas, are Vulkasil VN3, or FK 160 from Degussa, or Nipsil LP from Nippon Silica K.K. and others.

Examples of materials serving as non-transparent fillers known as non-reinforcing fillers are powdered quartz, diatomaceous earths, powdered crystoballites, mica, aluminum oxides, aluminum hydroxides, Ti oxides, Fe oxides, Zn oxides, chalks, or carbon blacks whose BET surface areas are from 0.2 to 50 m²/g. These fillers are available with a wide variety of trade names, examples being Sicron, Min-U-Sil, Dicalite Crystallite. The materials known as inert fillers or extenders with BET surface areas below 50 m²/g should advantageously comprise no particles (<0.005% by weight) above 100 μm for use in the inventive silicone rubbers, in order that further processing generates no problems during downstream processing, e.g. passage through sieves or nozzles, or the mechanical properties of the moldings produced therefrom are adversely affected.

Among the opacifying fillers are also in particular non-transparent, in particular inorganic, pigments.

The use of these opacifying fillers is preferred only when transparency is not important and their assistance is needed in order to bring about other functional properties, examples being pigmentation or electrical properties.

As the person skilled in the art knows, a filler can also be a pigment. For clarification, the intention is that all of the inorganic pigments included in the term filler as component (c) for the present invention, whereas all of the remaining pigments and dyes, in particular organic dyes and stabilizers, be included in the definition of the auxiliaries (e).

The term filler (c) means fillers including any possible hydrophobicizing agents and, respectively, dispersing agents and, respectively, process aids which have been bonded to their surface and which influence the interaction of the filler with the polymer, e.g. influence thickening action, the preferred influence being reduction. The surface treatment of the fillers is preferably hydrophobicization with silanes or with siloxanes. It can by way of example take place in situ via addition of silazanes, such as hexamethyldisilazane and/or 1,3-divinyltetramethyldisilazane, with addition of water, and in-situ hydrophobicization is preferred. It can also take place with other familiar filler-treatment agents, for example with vinylalkoxysilanes, e.g. with vinyltrimethoxysilane, or with other silanes having unsaturated organofunctional groups, for example with methacryloxypropyltrialkoxysilanes, or else with poly-organosiloxanediols whose chain lengths are from 2 to 50 and which bear unsaturated organic radicals, with the aim of providing reactive sites for the crosslinking reaction.

Examples of commercially available silicas pre-hydrophobicized with various silanes are: Aerosil R 972, R 974, R 976, or R 812, or, for example, HDK 2000 or H30. Examples of trade names for materials known as hydrophobicized precipitated silicas or wet silicas are Sipemat D10 or D15 from Degussa.

These pre-hydrophobicized silicas are less preferred than the silicas hydrophobicized in-situ with silazanes. Vulcanizate properties and Theological properties, i.e. technical processing properties, of the silicone rubber mixtures can be influenced by the selection the amount of the type of the filler, its amount, and the nature of hydrophobicization.

In one preferred embodiment, the silicone composition used according to the invention comprises at least one reinforcing filler (c) which has at least a BET surface area of more than 50 m²/g, preferably more than 80 m²/g of BET surface area.

In this particularly preferred embodiment, the filler (c) used is an oxidic filler, obtainable via a process which encompasses the following steps:
a. mixing of at least one reactive silane i) with at least one oxidic filler, if appropriate in the presence of water,
b. removal of low-boiling-point constituents present in the mixture,
c. addition of at least one reactive silane ii), without addition of water and, if appropriate, heating of the mixture.
   Step a)

Step a) includes the mixing of at least one reactive silane i) with at least one oxidic filler, if appropriate in the presence of water. Step a) is advantageously in a temperature range from about room temperature (25° C.) to about 200° C. and about atmospheric pressure (1013 mbar) to about 30 bar. The mixing preferably takes place at room temperature and atmospheric pressure. The mixing is carried out in a conventional mixing apparatus, such as a kneader, dissolver, turbine mixer, screw mixer, stirred tank, preferably in a kneader or dissolver. The mixing time ranges by way of example from about 10 minutes to about 400 minutes. Step a) is carried out in the presence of water, and the reactive silane i) here has been selected from organo-silazanes, hexaorganodisilazanes, trialkylsilyl amines, trialkylsilyl oximes, trialkyl-silyl amides, or organoalkoxysilanes. In this case, water serves as reactant for formation of hydroxyl-functional intermediates of the reactive silanes mentioned. When organosilanols are used as reactive silanes i), addition of water can be omitted, but this does not exclude addition of water.

Water can moreover also serve as liquid continuous phase in step a), in which the reactive silane i), the oxidic filler, the abovementioned intermediates and cleavage products from the reaction of water and of reactive silanes i) have been dispersed or dissolved. The liquid continuous phase can moreover be formed via other solvents, such as inorganic or organic solvents, or low or high-viscosity polymers. This means that the polymers for whose reinforcement the filler is intended to serve can be present before modification of the filler has ended, or in other words that the modification of the filler can take place in the presence of the polymers to be reinforced or of the curing composition, for example in the presence of the component a) described below of a curable polyorganosiloxane composition.

The amount of water used in step a) has to be judged to be at least such as to permit hydrolysis of the reactive silanes i) mentioned. The amount of water added to the mixture in step a) is advantageously sufficient that the reaction products of the reaction of the reactive silane i) with the water can continue to remain in the aqueous phase and, respectively, can be adequately diluted. The amount of water is preferably at least about 5 parts by weight of water for 100 parts by weight of the silane i), and it is preferable that the amount of water used is about 10 to 50 parts by weight for 100 parts by weight of the reactive silane i).

If water is used as liquid continuous phase, this amount is always achieved. In this case, the amount of water used is preferably at least about 300 parts by weight for 100 parts by weight of the oxidic filler.

If a continuous phase other than water is used in step a), its amount is preferably at least about 150 parts by weight for 100 parts by weight of the oxidic filler.

Step a) of the mixing of the reactive silane i) with the oxidic filler can optionally also be carried out in the presence of a catalyst. A catalyst is preferably present when organoalkoxysiloxanes or organosilanols are used as reactive silanes i). The catalysts include by way of example: weak bases and acids whose pKₐ is from 4 to 9. Examples include: ammonia, alkylamines, carboxylic acids, hydrogencarbonates, hydrogenphosphates, -sulfates, acidic salts of carboxylic acids, carbonic half-esters, etc. The amounts advantageously used of the catalyst are from 0.5 to 20% by weight, based on the amount of the reactive silane i).

The amounts used in step a) of the reactive silane i) and of the oxidic filler depend inter alia on the type of the material, e.g. on the specific surface area of the filler. It is advantageous to use at least about 3 parts by weight of the reactive silane i) for 100 parts by weight of the oxidic filler, in order to achieve adequate modification of the filler in step a). An amount of less than 3 parts by weight of the reactive silane i) for 100 parts by weight of the oxidic filler is generally less preferred, since surface modification is likely to be insufficient. The amount preferably used of the reactive silane i) is at most about 30 parts by weight of the reactive silane i) for 100 parts by weight of the oxidic filler. The preferred range of amounts of the reactive silane i) used is about 8 to 15 parts by weight of the reactive silane i) for 100 parts by weight of the oxidic filler.

The reactive silane i) used in step a) is a silane capable of forming suitable reactive intermediates capable of reaction with the surface of an oxidic filler, if appropriate via reaction with water. These reactive silanes i) are preferably selected from the group composed of organosilazanes, hexaorganodisilazanes, organosilanols, trialkylsilyl amines, trialkylsilyl oximes, trialkylsilyl amides, or organoalkoxysilanes. The reactive silanes i) are more preferably selected from hexaorganodisilazanes and organosilanols. Particular preference is given to hexamethyldisilazane, 1,3-divinyltetramethyldisilazane, trimethylsilanol, and vinyldimethylsilanol.

The oxidic filler used in step a) can be any metal oxide. It is advantageously selected from silicas, aluminum oxides, aluminum hydroxides, titanium oxides, these being prepared by various processes, for example via flame hydrolysis, precipitation processes, etc.

The BET specific surface area of these oxidic fillers is preferably at least about 50 m²/g, more preferably at least about 90 m²/g. Examples include: fumed silicas, such as Aerosil (Degussa), HDK (Wacker), Cab-O-Sil (Cabot). One preferred filler which is treated according to the invention is silica, more preferably with a BET specific surface area of at least about 200 m²/g.

According to the invention, it is also possible to use a mixture of one or more, in particular two, fillers with different specific surface areas. Suitable selection of different, in particular two, fillers with different specific surface areas achieves the effect of the invention, namely retaining very high flowability of unhardened polymer compositions and at the same time avoiding impairment of mechanical (vulcanizate) properties in the hardened polymer composition, i.e. excessive reinforcing effect.

Step b)

Step b) includes the removal of low-boiling-point constituents from the mixture obtained in step a) via setting of pressure and temperature conditions such that the low-boiling-point constituents present in the mixture evaporate. These low-boiling-point constituents are in particular constituents whose boiling point is below 180° C. at atmospheric pressure (1013 mbar), e.g. water, ammonia, alcohols, amines, hydroxylamines, amides, and silanols, these having formed in step a). Examples of suitable pressure and temperature conditions are temperatures of from 30 to 250° C. and pressures of from about 0.01 to 1013 mbar. Temperatures above 250° C. are less preferred in step b), since decomposition of the liquid continuous phase can occur, in particular when this involves liquid polymers. Evaporation of the low-boiling-point constituents preferably takes place at a temperature of from 120 to 180° C. and atmospheric pressure (1013 mbar). Step b) advantageously takes place in the mixing apparatus mentioned in step a) with stirring or kneading. Step b) is advantageously carried out until the content of the low-boiling-point constituents in the mixture has fallen to less than 10% by weight, more preferably less than 5% by weight, even more preferably less than 0.5% by weight. The content of low-boiling-point constituents in the mixture obtained in step b) is advantageously determined by keeping the mixture at a temperature of 150° C. and at 20 mbar for 45 minutes.

Step c)

Step c) of the inventive process includes addition of at least one reactive silane ii), without addition of water and if appropriate heating of the resultant mixture. Addition of the reactive silane ii) after removal of the low-boiling-point constituents in step b) advantageously takes place after setting of pressure and temperature conditions under which the period of contact between the reactive silane ii) and the pretreated oxidic filler permits sufficient reaction of the two components.

Admixture of the reactive silane ii) can by way of example take place at a temperature from room temperature to 150° C., preferably at atmospheric pressure. Addition preferably takes place at room temperature.

After addition of the reactive silane is complete, the temperature can, if appropriate, be increased as long as a the silane remains for a certain time in the mixture and, respectively, remains in contact with the pretreated oxidic filler.

The period of contact after completion of addition should advantageously be at least about 30 minutes. The period of contact depends on the temperature of contact, on the reactivity of the silanes ii), and also on their concentration in the mixture. The period of contact can be up to 30 days, in particular when contact takes place at room temperature. In principle, it is possible to use the filler after treatment with the silane ii) without a further removal operation. However, it is advisable, again after step c), to remove low-boiling-point components remaining in the mixture, for example excess silane ii), and also reaction products thereof, from the mixture in a further step, which in principle corresponds to step b). The conditions for this further removal step can correspond in essence here to the conditions for step b). Steps b) and c) can be repeated one or more times, if appropriate.

The reactive silanes ii) of step c) can be identical with or different from the reactive silanes used in step a). It is preferable that the reactive silanes used in step c) are the same as those used in step a). The reactive silanes ii) of step c) are preferably selected from the group composed of organosilazanes, hexaorganodisilazanes, trialkylsilyl amines, trialkylsilyl oximes, or trialkylsilyl amides. The reactive silanes ii) are more preferably selected from hexaorganodisilazanes.

The amount used in step c) of the reactive silane ii) is generally smaller than the amount used in step a) of the reactive silane i). The amount of the reactive silane ii) used in step c) depends, for example, on the amount of the reactive silane i) used in step a). The basic rule is that as the amount of the reactive silane i) used in step a) decreases, the amount of the reactive silane ii) used in step c) increases. It is advantageous to use less than about 15 parts by weight of the reactive silane ii) for 100 parts by weight of the oxidic filler, preferably less than about 3 parts by weight of the reactive silane ii), in order to achieve sufficient modification of the filler in step c). An amount of less than 0.1 part by weight of the reactive silane ii) for 100 parts by weight of the oxidic filler is generally less preferred, since the amount cannot sufficiently dependably enter into interaction with the surface of the oxidic filler.

Step c) is carried out without addition of water. The reason for this is that, surprisingly, it has been found that the effect of addition of water, as takes place in step a), in step c) is insufficient reduction of pseudoplasticity in the composition with the polymers.

The amounts added of the surface-modified oxidic fillers (c) obtained by the inventive process to the abovementioned compositions are preferably from about 0.001 to about 50 parts by weight per 100 parts by weight of the polymers a) +b) or of the crosslinkable compositions. A more preferred range is from about 15 to about 45 parts by weight of the modified oxidic filler for each 100 parts by weight of the polymers a) +b).

The inventive process produces oxidic fillers which generate less thickening than the fillers hydrophobicized by the previous processes of the prior art, for identical initial surface area.

The use of this specific filler gives particularly flowable silicone rubber compositions, with no impairment of the mechanical properties of the cured thick-walled silicone elastomers. This is particularly applicable when the presence of polyethers as surfactant for hydrophilicization of the surface of the silicone elastomers undesirably thickens the unhardened silicone rubber compositions. When the modified oxidic fillers obtained by the process described above are incorporated into the silicone rubber compositions used according to the invention, even in the presence of polyethers, the resultant thickening effect, which restricts the processability of the polymer compositions, is only slight. This is a particular advantage when the intention is that, after light-activation, the silicone rubber composition used according to the invention be transferred to a mold without pressure, or that these, applied to a substrate, are to flow under their own weight.

Component d) (catalyst)

Component (d), the hydrosilylation catalyst, preferably contains at least one metal selected from the group composed of Pt, Pd, Rh, Ni, Ir or Ru. The hydrosilylation catalyst can be used in metallic form, in the form of a complex compound, and/or as salt. The catalysts can be used with or without support materials in colloidal or pulverulent conditions.

The noble-metal catalyst is preferably a photo-activatable platinum catalyst which provides sufficient pot life, i.e. processing time prior to gelling of the abovementioned components, once these have been combined. The intention is firstly that it permit rapid crosslinking, and secondly that it does not bring this about until the preparatory steps for conduct of complete vulcanization of a molding, such as those of the shaping process, mixing, and charging to a mold, have been concluded. Examples of photo-activatable catalysts include η-diolefin-σ-arylplatinum complexes, such as disclosed in U.S. Pat. No. 4,530,879, EP 122 008, EP 146307, or US 2003-0199603, and also platinum compounds whose reactivity can be controlled by way of example using azodicarboxylic esters, as disclosed in U.S. Pat. No. 4,640,939.

Photo-activatable platinum compounds that can be used are moreover those selected from the group whose reactivity using photo-activatable ligands, such as diketones, e.g. benzoylacetones or acetylenedicarboxylic esters, and platinum catalysts embedded into photo-degradable organic resins. Other Pt catalysts are mentioned by way of example in U.S. Pat. No. 3,715,334 or U.S. Pat. No. 3,419,593, and Lewis, Colborn, Grade, Bryant, Sumpter, and Scott in Organometallics, 1995, 14, 2202-2213.

Photo-activatable catalysts can also be formed in-situ in the silicone rubber composition used, by using Pt⁰-olefin complexes and adding appropriate photo-activatable ligands thereto.

Pt⁰-olefin complexes are prepared by way of example in the presence of 1,3-divinyltetramethyldisiloxane (M^{VI}₂) via reduction of hexachloroplatinic acid or of other platinum chlorides.

The photo-activatable platinum catalysts that can be used here are not restricted to these abovementioned examples.

The amount of component (d) is preferably 0.1-5000 ppm, preferably 0.5-1000 ppm, more preferably 1-500 ppm, particularly preferably 2-100 ppm, calculated as metal, based on the weight of components (a) to (c).

The rate of hydrosilylation is determined by the selected catalyst compound, by its amount, and also by the nature and amount of additional inhibitor component (e).

The amounts of the catalyst are subject to an upward limit by virtue of the costs arising, and also to a lower limit by virtue of dependability of catalytic action. The consequence is that amounts above 100 ppm of metal are mostly uneconomic, while amounts below 1 ppm do not provide dependability.

Particular preference is given to a concentration of components (d) at which the concentration of the metal is 1-10 ppm, still more preferably 1-5 ppm.

Supports that can be used for the catalysts are any solid substances which do not inhibit hydrosilylation undesirably, or reduce transparency for photo-activation. The supports can be selected from the group of the pulverulent silicas or pulverulent silica gels or organic resins or polymers, and their use can be determined by the transparency desired, preference being given to non-opacifying supports.

Auxiliaries (e)

Inhibitors

It is known that the rate of the hydrosilylation reaction can be influenced via a number of additional compounds, known as inhibitors (e). This method can extend influence over the rate of crosslinking after photo-activation, thus determining the temperature and the time needed for the silicone composition or rubber mixture to harden or vulcanize after photo-activation to give an elastomeric molding.

Advantageous inhibitors for the inventively photo-activatable hydrosilylation at platinum concentrations above 30 ppm of platinum are inhibitors such as vinylsiloxanes, 1,3-divinyltetramethyldisiloxane, or tetravinyltetramethyltetracyclosiloxane. It is also possible to use other known inhibitors, for example ethynylcyclohexanol, 3-methylbutynol, or dimethyl maleate.

The inhibitors serve to delay the crosslinking reaction in a desired manner after photo-activation.

In principle, it is possible to use any of the inhibitors known for the class of the platinum metals group, if a sufficiently long processing time has not been achieved beforehand via selection of the ligands of the catalyst (d). In a preferred embodiment, the catalyst is used without the inhibitor.

Examples of the wide variety of known inhibitors are unsaturated organic compounds, such as ethylenically unsaturated amides (U.S. Pat. No. 4,337,332); acetylenic compounds (U.S. Pat. No. 3,445,420, U.S. Pat. No. 4,347,346), isocyanates (U.S. Pat. No. 3,882,083); unsaturated siloxanes (U.S. Pat. No. 3,989,667); unsaturated diesters (U.S. Pat. No. 4,256,870, U.S. Pat. No. 4,476,166 and U.S. Pat. No. 4,562,096), hydroperoxides (U.S. Pat. No. 4,061,609), ketones (U.S. Pat. No. 3,418,731); sulfoxides, amines, phosphines, phosphites, nitrites (U.S. Pat. No. 3,344,111), diaziridines (U.S. Pat. No. 4,043,977).

The best known class of inhibitors is that of the alkynols, as described in U.S. Pat. No. 3,445,420. Examples of these are ethynylcyclohexanol and 3-methylbutynol, and the unsaturated carboxylic esters of U.S. Pat. No. 4,256,870, and also diallyl maleate and dimethyl maleate, and the fumarates of U.S. Pat. No. 4,562,096 and U.S. Pat. No. 4,774,111, such as diethyl fumarate, diallyl fumarate, or bis(methoxyisopropyl) maleate.

Preferred inhibitors from the unsaturated carboxylic esters are the maleates and fumarates of the general formula
R^{W}(OW)ᵥO₂CCH═CHCO₂(WO)ᵥR^{w}
in which:
R^{W} is selected from the group of the C₁-C₁₀ alkyl radicals, such as methyl, ethyl, propyl, isobutyl, butyl, etc., and from aryl radicals, such as phenyl or benzyl, and an alkenyl radical, such as vinyl or allyl,
W is selected independently from divalent C₂-C₄-alkylene radicals, and the value of the index ‘v’ is 0 or 1.

The amount of the inhibitor component is selected in such a way that the desired crosslinking time can be suitably set under the selected processing conditions, i.e. time and temperature, in particular with appropriate consideration of the catalyst (d) and of the other components. The amount of the inhibitor component is preferably from 0.0001 to 2% by weight of one or more inhibitors, based on the amount of components (a) to (c).

If the inhibitor component is used, it is preferable to add about 0.001 to 0.5% by weight, particularly preferably from 0.05 to 0.2% by weight, of alkynols, metal contents of component (d) being from 10 to 100 ppm.

The inhibitor is preferably selected from the group composed of alkynols and vinylsiloxanes.

An advantage of the inventive use in comparison with purely thermally curing systems is that it is possible to omit use of inhibitors without any need to accept shortened pot lives.

The addition-crosslinking silicone rubber mixtures used according to the invention moreover optionally comprise further auxiliaries (e), e.g. plasticizers, or release oils, or hydrophobicizing oils, such as polydimethylsiloxane oils, without reactive alkenyl or SiH groups, with viscosity which is preferably 0.001-10 Pa·s at 25° C. Additional mold-release agents can also be used, examples being fatty acid derivatives or fatty alcohol derivatives. Compounds advantageous here are those which demix rapidly and migrate to the surfaces. Stability after exposure to hot air can by way of example be increased using known hot-air stabilizers, such as Fe compounds, Ti compounds, Ce compounds, and organic salts of these, preferably their organic complexes. The moldings obtained according to the invention can also comprise organic dyes, such as opacifying or non-opacifying dyes.

The entire amount of the auxiliaries (e) is preferably from 0 to 15 parts by weight, based on 100 parts by weight of component (a) and (b).

The compositions which are curable after photo-activation and which can particularly preferably be used for production of thick-walled molding products or of thick-walled coatings are characterized in that this composition comprises:
from 3 to 99% by Aeight of at least one polysiloxane a) containing alkenyl groups,
from 0.2 to 60% by weight of at least one SiH-functional polysiloxane b),
from 0.1 to 60% by weight of at least one filler c),
at least one photo-activatable catalyst d), corresponding to from 1 to 500 ppm of metal content,
from 0 to 30% by weight of one or more auxiliaries e),
based in each case on the entire amount of components a) to c).

In one preferred embodiment, the silicone composition used according to the invention comprises:
a) 100 parts by weight of at least one polyorganosiloxane which contains alkenyl groups, its viscosity range being 0.025 and 500 Pa·s (25° C.; shear gradient D of 1 s⁻¹),
b) from 0.1 to 200 parts by weight of at least one polyorganohydrosiloxane, using from 0.5 to 20 mol, preferably from 1 to 5 mol, of SiH groups per mole of alkenyl groups here,
c) if appropriate from 1 to 100 parts by weight of one or more fillers,
d) from 0.5 to 1000 ppm of at least one hydrosilylation catalyst, calculated as metal, based on the amount of components (a) to (c),
e) if appropriate from 0.0001 to 2% by weight of one or more inhibitors, based on the amount of components (a) to (c), and, if appropriate, further auxiliaries.

The silicone rubber compositions used according to the invention can be obtained via mixing of components (a) to (e), the substances preferably being combined here in preferred sequences, and at least two submixtures preferably being combined immediately prior to activation.

The individual components of the silicone rubber mixture are preferably mixed here in suitable stirred vessels, or static mixers, in particular dynamic static mixers, and it is also possible to use twin-fluid mixing nozzles, as is conventional in spraying with reactive coatings.

It is also possible to combine any of the possible static mixers and simple spray nozzles. Preferred static mixers have been found to be dynamic static mixers, which promote the mixing process with the aid of rotating mixing elements.

A preferred method for preparation of the two submixtures mixes the polyorganosiloxanes (a), reinforcing fillers (c), and, if appropriate, the hydrophobicizing agent related to (c), preferably hexamethyldisilazane and, if appropriate, divinyltetramethyldisilazane, with water, or mixes the silanols previously prepared therefrom, preferably at temperatures of from 10 to 100° C., for at least 20 minutes to 120 minutes, in a mixing assembly suitable for high-viscosity materials, e.g. a kneader, dissolver, planetary mixer, or other screw mixers. The excess hydrophobicizing agents and water are then evaporated at atmospheric pressure at from 120 to 160° C., and then, if appropriate, in vacuo at a pressure of from 100 to 20 mbar.

Into this mixture, known as a parent mixture, further components are mixed, advantageously for from 10 to 120 minutes at 10-160° C., as a function of the desired composition of the submixtures comprising (a) and (c), examples being the photo-activatable component (d), and (e), and, if appropriate, the material known as non-reinforcing filler (c). This gives by way of example a submixture (1). The amount of this component with the light-activatable catalyst will advantageously be kept small in comparison with the other submixture, because the former has to be stored with protection from the light.

A further submixture (2) is obtained by mixing the hardener (b) with the parent mixture. It is moreover possible, if appropriate, to admix components (e) and, if appropriate, the material known as non-reinforcing filler (c) advantageously for from 10 to 60 minutes at 10-160° C. In further preferred embodiments, this non-reinforcing filler is introduced after light-activation of the submixtures. The reactive photo-activated and, respectively, photo-activatable silicone composition is obtained via combination of the submixtures (1) and (2) advantageously with defined ingress, or defined exclusion, of light.

In one preferred embodiment of the process, the photo-activatable, addition-crosslinking silicone rubber mixtures are prepared by way of preparation of at least two submixtures (1) and (2), which comprise more than one, but not all, of components (a) to (e).

The preferred division into submixtures serves for better handling and storage. By using division of the reactive and catalyzing components, comprising constituents (a) to (e), it is possible to delay the reaction of these components with one another until immediately prior to combination of all of the constituents prior to photo-activation and shaping and, respectively, addition of further additives, for example pigments.

For preparation of non-reacting submixtures, by way of example, mixing is used to prepare a submixture (1), composed of components (a), (c), and (d), and, if appropriate, (e), and also to prepare a submixture (2), composed at least of components (b) and, if appropriate, (e). For reasons of advantageous handling, the submixture (2) is mixed from components (a), (b), (c), and, if appropriate, (e).

In principle, it is possible to use any of the possible submixtures for prolonged storage, as long as this does not lead to simultaneous presence and activation of component (a), (b) and (d) in a submixture. For this reason, it is advantageous to separate component (b) and (d) when (a) is simultaneously present or to separate (b) and (a) when (d) is simultaneously present in the same submixture.

Constituent (d) can be provided with some degree of advantage in any of the components, as long as the components (a) and (b) which react with one another are not simultaneously present alongside one another, and component (d) can be stored with protection from light. The inhibitor (e) can be present in any of the submixtures, preference being given to combination in a submixture with (b).

In order that the silicone composition used according to the invention has sufficient flowability, viscosity immediately after mixing of the submixtures described above with catalyst component (d), prior to shaping, is less than 3000 Pa·s (25° C.) at a shear gradient D=10 s⁻¹, preferably less than 1000 Pa·s. The ratio of modulus of elasticity to lost modulus, i.e. G′, to G,″ is below 1.

In one preferred embodiment of the inventive process, the silicone composition is curable, after from 0.01 to 100 sec of photo-activation, within a period of less than 6 min, i.e. a tack-free surface is obtained after this time. Tack-free means that it is possible to remove a reactive casting resin which is hardening on the surface.

In a further preferred embodiment of the inventive process, the gel time of the silicone composition is from 30 to 900 s at 30° C., measured in a UV vulcameter with valuation to ASTM D4473.

For photo-activation, the light-activatable, curable compositions used for production of thick-walled molding products and coatings are irradiated with light whose wavelength is in the range from 200 to 500 nm.

For this, the light-activatable, curable composition is preferably charged to a mold whose surface has at least one region composed of a UV-permeable material, which is composed of quartz or of UV-permeable plastics. These are either molds or irradiation units which are composed entirely of a UV-permeable material or which have a window whose size is more than 0.1 cm² of clear aperture with respect to the light source.

In one embodiment, the composition is used in such a way that photo-activation takes place at a location separate from the shaping. In this use, the irradiation time is characterized in that it is shorter than the gel time of the curable siloxane composition. The irradiation time for a given irradiation intensity is preferably less than 1/10 of the gel time. The result of this is that the resultant, still flowable composition can, if appropriate after filler addition and/or pigment addition, be transferred to a downstream mold or to a subsequent shaping process, or can be applied to a substrate, and hardens there without further irradiation, if appropriate at an elevated temperature.

In a further embodiment, the inventive composition can be used in such a way that, prior to transfer to a mold, prior to a shaping process, or prior to application to a substrate, the light-curable composition initially subjected to irradiation is admixed with at least one pigment and/or filler, particularly when these additives reduce transparency.

The inventive compositions can be used for production of high-tension insulators, of formed-in-place gaskets, of prosthetic molding products or impressions, or of a conformal coating.

The compositions described above, and particularly the compositions comprising the surface-modified oxidic fillers obtained by the inventive process, are used by way of example for production of molding products, impression compositions, or coatings. These fillers serve here to increase the level of mechanical (vulcanizate) properties. Preferred examples of the molding products mentioned are impression compositions, such as dental impression compositions, gaskets, such as those known as formed-in-place gaskets, the coatings known as conformal coatings (embedding compositions), cable (plug) gaskets, cable fittings, any desired molding products, such as (embossing) stamps and (embossing) pressure pads for the pad-printing process, printing inks (low-viscosity compositions for the identification marking or inscription of flexible substrates). Impression compositions or molding products also includes production of prosthetic products using the inventive curable composition in the form of impression compositions or else in the form of molding products for use, examples being replacement limbs, prosthetic, cosmetic, or medical aids adapted to body shapes, e.g. ear-pieces for hearing devices or noise protection for the workplace, body-simulating products for provision of aesthetically designed prosthesis, footbeds, insoles, auxiliaries for seating and for beds, e.g. mattresses or headrests, or for the fixing of limbs during medical treatment

The molding products, impression compositions, or coatings mentioned, produced according to the invention, are advantageously obtained via curing of the compositions after exposure to light. The compositions are preferably cast in molds or supplied as photo-activatable, curable casting composition.

The light transmittance of the thick-walled molding products or coatings obtained by the inventive process is preferably less than 10%, more preferably less than 5%, measured at 10 mm thickness, as transmittance, using a photometer at 400 nm.

The invention also provides a process for production of thick-walled molding products or of thick-walled coatings, characterized in that the light-activatable, curable composition is irradiated with light whose wavelength is in the range from 200 to 500 nm, the irradiation time being shorter than the gel time, and the resultant composition is then transferred to a mold into a shaping process or applied to a substrate, and then, without further irradiation, is cured if appropriate at an elevated temperature. Determination of the gel time permits precise prediction of the processing parameters, selection of advantageous processing techniques, and setting of the desired process conditions.

For precise determination of crosslinking times, crosslinking is carried out either in a vulcameter to DIN 53529 or, particularly preferably here, using a UV vulcameter from Thermo Haake Karlsruhe, in order to be able to monitor the crosslinking reaction initiated via light-activation. Measurement of the values known as t values, such as t₁₀ and t₉₀, can be used here to determine the time after which, at a given temperature, the torque has risen by 10% and, respectively, 90%, based on the final torque value after complete crosslinking.

Measurement of the gel point using a UV vulcameter, in particular in accordance with the criteria of ASTM D4473, has proven advantageous as a criterion for the processability of the preferably relatively low-viscosity siloxane compositions. Similar evaluations are found in Thomas G. Metzger, The Rheology Handbook, Vincentz Verlag 2002, page 143, or in accordance with DIN ISO 16945, DIN ISO 9396 with a gel timer. The gel point here gives a rheological indication of the condition in which the modulus of elasticity G′=G″, where G″ means the loss modulus. The gel time is accordingly the time after the start of irradiation and standing at 25° C. until the gel point has been reached, at which G′=G″.

This can be used to check the crosslinking time, and arrive at a conclusion on processability, and arrive at measures for control of reaction rate.

A further embodiment included within these methods for use of the inventive compositions consists in that prior to transfer to the mold, or prior to the shaping process or prior to application to a substrate, the light-activatable, curable composition subjected to irradiation is admixed with at least one pigment and/or filler. This means by way of example that the light-activatable composition passes through a light-exposure unit, e.g. a transparent feed line to a hardening mold, where it is activated and then a shaping process is introduced, where the curing then takes place.

A further process for production of thick-walled molding products or of thick-walled coatings, is characterized in that the light-activatable, curable composition is charged to a mold whose surface has at least one region composed of a UV-permeable material which is composed of quartz or of UV-permeable plastics, and is irradiated with light whose wavelength is in the range from 200 to 500 nm. This window suitable for light-activation will advantageously have at least a size as defined above if it is present as a single window. If there is a large number of windows, it is also possible to use smaller areas.

The process for light-activation or the use of the light-activatable curable compositions takes place with activation using UV irradiation whose wavelength is from 180 to 700 nm, if appropriate using sensitizers, preferably at from 200 to 500 nm. Addition of commercially available sensitizers, such as benzophenones, etc., permits activation using longer-wavelength light or with better light yields.

In the inventive processes, or in the inventive use of the composition for the production of thick-walled molding products or coatings, a UV radiation source is selected for light-activation from the group of the UV sources, such as xenon lamps which can be operated as flash lamps, undoped or iron- or gallium-doped mercury lamps, black-light lamps and excimer lamps. The light-irradiation intensity (radiation dose x light-irradiation time per unit of volume) is selected as a function of the selected process, of the selected composition of the temperature of the composition in such a way as to give a sufficient processing time.

The desired abovementioned thick-walled molding products or coatings are obtainable by the abovementioned processes. Thick-walled molding products obtained by the inventive process are particularly those whose capacity is such that they can accept or enclose a sphere whose diameter is at least 1 mm, preferably at least 3 mm, more preferably at least 5 mm, and still more preferably at least 10 mm.

It is therefore possible to produce thick-walled molding products, e.g. a high-tension insulator or a formed-in-place gasket, without direct exposure of the molded product or of the gasket to light. The low level of temperature during curing, from 0° C. to preferably 80° C., more preferably from 10 to 40° C., brings about particularly little shrinkage. This gives markedly easier demolding, in particular of large-volume or large-surface-area moldings with undercuts or depressions.

The large-volume molding products produced have excellent electrical stability, for example high-tension tracking (IEC 5 87) or arc resistance.

The compositions and, respectively, the process can also be used to permit production of thick-walled coatings, such as those of a conformal coating. These coatings serve by way of example for protection from dust or mechanical shock, or are used as damping layer for mechanically loaded relays, electronic circuits in vehicles, in aircraft, in pumps, in movable assemblies, or in hard-disk drives in computers.

### EXAMPLES

Conduct of light-curing and measurement of rate of crosslinking.

Various types of lamp are used as light sources for curing:
(XA) Flash lamp (xenon) (Blassing, Essen), with emission power of 34.9 J/individual flash at 12.5 Hz.
(XB1) High-pressure mercury UV lamps with (iron-, gallium-doping) rating of 400-8000 W, Hönle, Munich,
(XB2) Heraeus Noblelight Hanau medium-pressure source without and with doping (iron, gallium) with rating: 150-8000 W
(XC) Philips Cleo Swift HPA 400 W medium-pressure UV lamp.

The methods of examples 4 to 8 were used to vulcanize the silicone composition crosslinking after light-activation:

For determination of rate of crosslinking outside the processing method according to the invention, the reactive mixtures were also evaluated using a RheoStress 600 rheometer from Thermo Haake, Karlsruhe, composed of a measuring unit with a quartz glass plate (below)/20 mm titanium plate (above).

A UV-LQ 400/C UV point light source from Dr. Gobel UV-Elektronik GmbH, Ettlingen, equipped with Philips Cleo Swift HPA 400 W lamp with a distance from specimen of 33 mm, limited to 80% power was said. Haake RheoWin Pro software was used for evaluation of the test results.

For this, 0.75 g of a mixture which had been produced in advance manually, with exclusion of light, using a stirrer rod, from submixtures 1 to 3 of examples 2 or 3 after individual irradiation was introduced, these having been previously degassed in vacuo at 20 mbar. This mixture was then exposed to the UV point light source for the respective time mentioned. The intention here was inter alia to simulate approximately the irradiation times used in the respective processes to the rate of crosslinking.

The moduli G′ and G″ were measured with the rheometer by oscillation in time-deformation mode (Sweep 2 Hz, CD, controlled stress 0.01±0.001 (device set to “dimensionless”)) over 10 minutes at 25° C.

### Example 1

### Conformal Coating Composition

Submixture 1

5 parts by weight of dimethylvinylsiloxy-endcapped polydimethylsiloxane (a1) whose viscosity is 200 mPa·s (25° C.) are mixed in a stirred vessel with exclusion of light. 0.26 part by weight of a catalyst which is composed of 1000 parts by weight of a linear vinyl endcapped polydimethylsiloxane whose viscosity is 1 mPa·s at 25° C. and whose vinyl content is 0.13 mmol/g, and also 1 part by weight of trimethyl(methyl)cyclopentadienylplatinum (Strem) whose platinum content is 61.1%, with exclusion of light. The mixture is stored with exclusion of light prior to irradiation.

Submixture 2

45 parts by weight of dimethylvinylsiloxy-endcapped polydimethylsiloxane (a1) whose viscosity is 200 mPa·s (25° C.) and whose vinyl content is 0.3 mmol/g, 4 parts by weight at about 25° C. of a trimethylsiloxy-endcapped polyhydromethyldimethylsiloxane of the formula M₂D₂₀D^{H}₂₀ are mixed in a stirred vessel with 7.4 mmol/g of SiH whose viscosity is 40 mPa·s.

### Example 2

### Hard Mixture

Preparation of a High-Hardness Silicone Composition Which, After Activation by UV Light, is Non-Transparent

51.05 parts by weight of a dimethylvinylsiloxy-endcapped polydimethylsiloxane (a1) whose viscosity is 0.2 Pa·s at 25° C. and 12.5 parts by weight of dimethylvinylsiloxy-endcapped polydimethylsiloxane (a1) whose viscosity is 1 Pa·s at 25° C. are mixed, in a kneader, with 24 parts by weight of EXP 6303 silica (Degussa with BET 85 m²/g) (c), for about one hour at from 30° C. to 40° C.

Submixture 2

32.25 parts by weight of a dimethylvinylsiloxy-endcapped polydimethylsiloxane (a1) whose viscosity is 0.2 Pa·s at 25° C. and 12.5 parts by weight of dimethylvinylsiloxy-endcapped polydimethylsiloxane (a1) whose viscosity is 1 Pa·s at 25° C. are mixed, in a kneader, with 24 parts by weight of EXP 6303 silica filler (c) for about one hour at from 30° C. to 40° C.

After cooling, 68.7 g of this submixture are taken, and 18.8 parts by weight of a crosslinking agent composed of a trimethylsiloxy-endcapped polydimethylhydromethylsiloxane and an SiH content of 7.4 mmol/g 40 mPa·s at 25° C. of the general formula M₂D₂₀D^{H}₂₀ are added thereto.

Submixture 3

Submixture 3, from which light has been excluded, comprising 2.9 parts by weight of a catalyst which has been mixed from 1000 parts by weight of a linear vinyl-endcapped polydimethylsiloxane whose viscosity is 1 Pa·s at 25° C. and whose vinyl content is 0.13 mmol/g, and also 1 part by weight of trimethyl(methyl)cyclopentadienylplatinum (Strem) whose platinum content is 61.1%, is added, as described below, to submixtures 1 and 2. Submixture 3 and the submixtures comprising the catalyst (d) have to be stored with exclusion of light.

### Example 3

### Preparation of a Silicone Composition for Insulators

19.8 parts by weight of dimethylvinylsiloxy-endcapped polydimethylsiloxane (a1) whose viscosity is 10 Pa·s at 25° C., 2.4 parts of hexamethyldisilazane, 0.028 part by weight of 1,3-divinyltetramethyldisilazane, and 1.14 parts by weight of water are mixed, in a kneader, and then are mixed with 9.3 parts by weight of fumed silica (c) whose BET surface area is 300 m²/g, the mixture is heated to about 100° C. and stirred for about one hour and then freed at from 150° C. to 160° C. from water and from excess silazane/silanol residues, via evaporation (including with vacuum at p=20 mbar). The mixture is then diluted with 16.75 parts by weight of a dimethylvinyl-siloxy-endcapped polydimethylsiloxane (a2) whose viscosity is 10 Pa·s.

Submixture 2

19.8 parts by weight of dimethylvinylsiloxy-endcapped polydimethylsiloxane (a1), 2.73 parts by weight of hexamethyldisilazane, 0.035 part by weight of 1,3-divinyltetramethyldisilazane, and 1.14 parts by weight of water are mixed in a kneader, and also mixed with 10.95 parts by weight of fumed silica (c) whose BET surface area is 300 m²/g, and the mixture is then heated to 100° C. and stirred for about one hour and then freed at from 150° C. to 160° C. from water and from excess silazane/silanol residues, via evaporation (including with vacuum at p 20 mbar). This mixture is then diluted with 2.26 parts by weight of a dimethylvinylsiloxy-endcapped polydimethylsiloxane (a2) whose viscosity is 10 Pa·s.

After cooling, 34 g of this submixture are taken and 10.9 parts by weight of a crosslinking agent mixture composed of dimethylhydrosiloxy-endcapped poly-dimethylhydromethylsiloxane whose viscosity is 1000 mPa·s at 25° C. and whose SiH content is 0.12 mmol/g of the general formula M^{H}₂D₂₀₀, 1.14 parts by weight of a trimethylsiloxy-endcapped polydimethylhydromethylsiloxane and an SiH content of 4.15 mmol/g 35 mPa·s at 25° C. of the general formula M₂D₂₀D^{H}₁₀, 0.57 part by weight of a trimethylsiloxy-endcapped polydimethylhydromethylsiloxane and an SiH content of 2.3 mmol/g whose viscosity is 40 mPa·s at 25° C. of the general formula M₂D₁₀₀D^{H}₂₀ are added thereto.

Submixture 3

Submixture 3, from which light has been excluded, comprising 1.88 parts by weight of a catalyst which has been mixed from 4000 parts by weight of a linear vinyl-endcapped polydimethylsiloxane whose viscosity is 1 Pa·s at 25° C. and whose vinyl content is 0.13 mmol/g, and also 1 part by weight of trimethyl(methyl)cyclopentadienylplatinum (Strem) whose platinum content is 61.1%, is added, as described below, to submixtures 1 and 2. Submixture 3 and the submixtures comprising the catalyst (d) have to be stored with exclusion of light.

### Example 4

### Curing in Open Mold

The two submixtures of example 1 were mixed, with exclusion of light, via tumbling movements in a vessel impermeable to light, and charged to a coated metal mold having a cylindrical mold cavity of diameter 40 mm and height 50 mm, with exclusion of light. After about 5 min of standing time, the mixture has become substantially free from bubbles. The open end of the cylinder is exposed to light, using the UV flashlamp (XA) at a distance of 40 mm for 120 sec. at 25° C. A cylindrical molding was then removed, its dimensions being in essence those of the cylindrical mold cavity. The Shore A hardness of the cylindrical molding was determined after various storage times at 25° C. to DIN 53505, not only on the surface but also on the cylindrical molding after it had been divided by cutting through its center.

| Storage time after | | Surface hardness [°] | Center hardness [°] |
|---|---|---|---|
| exposure to light | | Shore A | Shore A |
| 1 | min | 40 | 40 |
| 6 | h | 43 | 42 |
| 24 | h | 44 | 43 |

It is seen to be possible to produce thick-walled moldings which in essence have uniform overall hardening.

### Example 5

### Process for Production of Moldings by Means of Transparent Molds

A mixture composed of submixtures 1 and 2 of example 2 in the ratio 1:1, and also submixture 3, this amount being as stated in example 2, is charged to a quartz-glass tube (Heraeus quartz glass HSQ 300 wall thickness 3 mm) whose internal diameter is 52 mm and whose length is 104 mm with a metal plate flanged onto each end. The mixture was obtained by way of a two-component 900 Silko Mix feed machine from 2KM Marienheide, equipped with three-component mixing equipment (additive line) and with a static mixer of length 30 cm (Kennix). The material was charged, without bubbles, to a quartz glass tube, with exclusion of light, by way of metal lines at a charge rate of 100 cm³/min at an internal mold pressure of up to 10 bar, in about 120 seconds. After the charging procedure, the material is irradiated with an (XA) lamp at a distance of 40 mm, for 240 sec. The mold temperature increased to about 40° C. during the irradiation.

The cylinder removed from the quartz tube after 3 minutes has a surface hardness of 62° Shore A and center hardness of 61° Shore, these rising after 24 h to 65° Shore A.

The transmittance determined for a thickness of 10 mm is below 10% for measurement at 400 nm. The deviation of molding length from tube length is below 0.1% at 25° C.

This example shows that even filled thick-walled moldings can be obtained with uniform crosslinking and high hardness.

### Example 6

### Process with Light-Activation and with Heated Mold

The experiment of example 4 is repeated with the proviso that the quartz glass tube with flanged-on metal ends was heated to a temperature of 70° C.

The mixture composed of the submixtures of example 2 is mixed in the abovementioned ratios by way of the static mixer mentioned and is charged, without bubbles, at a charge rate of 100 cm³/min at an internal mold pressure of up to 10 bar. After the charging procedure, the material is exposed to light from an (XA) lamp at a distance of 80 mm, for 120 s at 60-70° C.

The cylinder removed from the quartz tube after 1 minute has a surface hardness of 63° Shore A and center hardness of 62° Shore, these rising after 24 h to 65° Shore A.

The deviation of molding length from the tubular mold is below 0.2% at 25° C. This example shows that irradiation of thick-walled molding products having uniform crosslinking gives these after a relatively short time, if they are cured in a heated mold.

### Example 7

### Production of a Thick-Walled Molding Product with the Aid of Light-Exposure Unit

The mixture composed of submixtures 1 and 2 of example 2 is mixed together in the ratio 1:1 and also using the ratio mentioned for submixture 3 by way of the apparatus from example 5, and passed, using a charge rate of 100 cm³/min, through a quartz glass tube whose internal diameter is 12 mm and whose length is 110 mm and whose wall thickness is 3 mm. Symmetrically surrounding the quartz tube, which is in a housing, there are three (XB 1) lamps at a distance of 40 mm, and the transparent tube of the light-exposure unit is continuously exposed to light from these, which are operated with power of 3×400 W.

The mixture of the subcomponents flowing through the equipment is irradiated for a calculated period of 8 sec at 30° C.

The activated silicone rubber composition flowing through the equipment is conveyed into a cylindrical mold, internal diameter 52 mm, length 104 mm, composed of glass with a metal end at each of the circular ends, the mold being kept at a temperature of 80° C. 132 seconds are needed to charge the material to the mold.

The cylinder removed after 4 minutes has surface hardness of 21° Shore A and center hardness of 20° Shore.

The deviation of the molding length from the tubular mold is below 0.2%.

If this mixture is introduced into the Haake UV vulcameter described above, the gel time obtained for a light-exposure time of 8 sec for the gel point G′=G″ (ASTM D4473) is 295 sec at 25° C.

The cured elastomer had the following properties after conversion to standard test sheets:

| | | |
|---|---|---|
| DIN 53504 tensile strength | N/mm², | 4.8 |
| Tensile strain at break | %, | 670 |
| ASTM 624 tear propagation resistance, test | N/mm | 38.7 |
| specimen B | | |
| DIN 53505 hardness | °Shore A, | 21 |
| Density | g/ml | 1.097 |
| IEC 587 high-tension tracking resistance | kV | 4.5 |
| Arc resistance | sec | 360 |
| Loss in weight | % by weight. | 1.12 |

This example shows that the inventive process permits irradiation of the siloxane composition, with sufficient subsequent time for charging the activated composition to a mold and, if appropriate, mixing it in advance with filler. This procedure also gives uniformly crosslinked, thick-walled moldings which have high mechanical strength, and also particularly good high-tension tracking resistance and arc resistance.

### Example 8

### Production of a Thick-Walled Molding Product with the Aid of a Light-Exposure Unit

The mixture composed of submixtures 1 and 2 of example 2 is mixed in the first mixing head and static mixer together in the ratio 1:1, and also using the ratio mentioned for submixture 3, by way of the apparatus from example 5, which in this case can feed four components, and is passed at a charge rate of 100 cm³/min through a quartz-glass tube whose internal diameter is 12 mm and whose length is 110 mm and whose wall thickness is 3 mm. Symmetrically surrounding the quartz tube, which is in a housing, there are three (XB1) lamps at a distance of 40 mm, and the transparent tube of the light-exposure unit is continuously exposed to light from these, which are operated with power of 3×400 W.

The mixture of the subcomponents flowing through the equipment is irradiated for a calculated period of 8 sec at 30° C.

Between the irradiation tube and the mold, 2^{nd} mixing head and a static mixer of length 30 cm (Kennix) was incorporated. A 4^{th} mixture was also conveyed to this by way of the abovementioned two-component 900 Silko Mix feed machine, and was composed of an amount of 3 cm³/min of a dimethylvinylsiloxy-endcapped polydimethylsiloxane (a1) whose viscosity was 20 Pa·s at 25° C. and which also comprised 17% by weight of pigments (carbon black+TiO₂) (Silopren® gray color paste), as 4^{th} component.

The activated silicone rubber composition flowing through the equipment is conveyed into a cylindrical mold, internal diameter 52 mm, length 104 mm, composed of glass with a metal end at each of the circular ends, the mold being kept at a temperature of 80° C. 133 seconds are needed to charge the material to the mold, and the mold comprises a dark gray molding substantially impermeable to light, its transmittance being well below 5% per 10 mm.

The cylinder removed after 4 minutes has surface hardness of 62° Shore A and center hardness of 61° Shore, these values rising after 24 h to 65° Shore A.

The deviation of the molding length from the tubular mold is below 0.2%.

If this mixture is introduced into the Haake UV vulcameter described above, the gel time obtained for a light-exposure time of 8 sec for the gel point G′=G″ (ASTM D4473) is 300 sec at 25° C.

This example shows that the inventive process permits production of a pigmented molding with no residual transparency above 60° Shore A via light-activation, this procedure giving uniformly crosslinked, thick-walled moldings.

1-26. (canceled)

27. A process for production of a light-activatable, curable siloxane for use in thick-walled molding products or thick-walled coatings, comprising contacting together:
a. at least one polyorganosiloxane having an average of at least two unsaturated organic groups per molecule,
b. at least one polyhydroorganosiloxane having an average of at least two SiH groups per molecule,
c. a filler, and
d. an auxiliary
in the presence of at least one photo-activatable catalyst, comprising a metal selected from the group consisting of Pt, Ru, Rh, Pd, Ir, and Ni.

28. The process of claim 27 wherein the polyorganosiloxane has the formula (I) containing alkenyl groups
[Mₐ₁D_{b1}T_{c1}Q_{d1}R²ₑ₁]ₘ₁ (I)
wherein M=R¹R₂SiO_{1/2}, D=R¹RSiO_{2/2}, T=R¹SiO_{3/2}, Q=SiO_{4/2},
wherein R=n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl,
wherein each R is optionally substituted with at least one F atom and/or at least one —O— group,
wherein R¹═R or an unsubstituted or substituted C₂-C₁₂-alkenyl radical,
wherein R² is selected from the group consisting of a divalent aliphatic n-, iso-, tert-, or cyclic C₁-C₁₄-alkylene radical; a C₆-C₁₄-arylene radical; and a C₆-C₁₄-alkylenearyl radical,
wherein R² bridges two of the siloxy units M, D and T, and
wherein m1=1-1000; a1=1-10; b1=0-3000; c1=0-50; d1=0-1; and e1=0-300.

29. The process of claim 27, wherein the polyhydroorganosiloxane is a linear, cyclic, or branched SiH-containing polyorganosiloxane of the general formula (II):
[Mₐ₄D_{b4}T_{c4}Q_{d4}R²ₑ₂]ₘ₃ (II)
wherein M=R³R₂SiO_{1/2}, D=R³RSiO_{2/2}, T=R³SiO_{3/2}, and Q=SiO_{4/2},
wherein R=n-, iso-, tert- or C₁-C₁₂-alkyl, C₁-C₁₂-alkoxy(C₁-C₁₂)alkyl, C₅-C₃₀-cycloalkyl or C₆-C₃₀-aryl, C₁-C₁₂-alkyl(C₆-C₁₀)aryl,
wherein each R is optionally substituted with at least one F atom and/or at least one —O— group,
wherein R³═R or hydrogen,
wherein R² is selected from the group consisting of divalent aliphatic n-, iso-, tert-, or cyclic C₁-C₁₄-alkylene radicals; C₆-C₁₄-arylene radicals; C₆-C₁₄-alkylenearyl radicals,
wherein R² bridges two of the siloxy units M, D and T, and
wherein m3=1 to 1000; a4=1 to 10; b4=0 to 1000; c4=0 to 50; d4=0 to 1; and e2 =from 0 to 300.

30. The process of claim 27, wherein the photo-activatable catalyst is a metal compound having at least one sigma-bonded alkyl or aryl radical.

31. The process of claim 27, wherein photo-activatable catalyst is a platinum compound.

32. The process of claim 27, wherein photo-activatable catalyst is (η⁵-methylcyclopentadienyl)trimethylplatinum.

33. The process of claim 27, wherein the filler comprises an oxidic filler having a BET surface area of 50 to 400 m²/g.

34. The process of claim 33, wherein the oxidic filler has been surface-treated with at least one reactive silane.

35. The process of claim 34, wherein the surface treated oxidic filler is made by a process comprising:
a. mixing of a first reactive silane with at least one oxidic filler, optionally in the presence of water;
b. removal of constituents present in the mixture having a boiling point less than 180° C. at atmospheric pressure;
c. addition of a second reactive silane, without addition of water and,
d. optionally heating the mixture.

36. The process of claim 27, wherein the curable siloxane composition comprises:
a. 3 to 99 wt % of a first polysiloxane containing alkenyl groups,
b. 0.2 to 60 wt % of a second polysiloxane containing SiH-functional groups,
c. 0.1 to 60 wt % of a filler,
d. at least one photo-activatable catalyst including 1 to 500 ppm of metal content, relative to the total weight of components (a) to (c), and
e. 0 to 30 wt % of one or more auxiliaries relative to the total weight of components (a) to (c).

37. The process of claim 27, wherein the light-activatable, curable composition is irradiated with light having a wavelength of from 200 to 500 nm.

38. The process of claim 37, further comprising charging the light-activatable, curable composition to a mold whose surface has at least one region comprising a UV-permeable material, selected from the group consisting of quartz and UV-perneable plastics.

39. The process of claim 37, wherein the irradiation time of the curable siloxane composition is shorter than its gel time, to form a flowable composition, which is transferred to a mold or applied to a substrate, and cured.

40. The process of claim 38, wherein, prior to transfer to the mold or prior to application to a substrate, the light-curable composition is mixed with at least one of a pigment and a filler.

41. The process of claim 27, wherein the thick-walled molding products or thick-walled coatings are selected from the group consisting of: high-tension insulators, formed-in-place gaskets, prosthetic molding products, prosthetic molding impressions, and conformal coatings.

42. The process of claim 27, wherein the light transmittance of the thick-walled molding products or coatings is less than 10%, measured at 10 mm thickness.

43. The process of claim 27, wherein the light-activatable, curable composition is irradiated with light having a wavelength from 200 to 500 nm, the irradiation time being shorter than the gel time of the composition, to form a flowable composition, which is transferred to a mold or applied to a substrate, and cured.

44. The process of claim 43, wherein prior to transfer to the mold or prior to application to a substrate, the light-activatable, curable composition subjected to irradiation is mixed with at least one of a pigment and a filler.

45. The process of claim 27, wherein the light-activatable, curable composition is charged to a mold whose surface has at least one region composed of a UV-permeable material comprising quartz or UV-permeable plastics, and is irradiated with light having a wavelength of from 200 to 500 nm.

46. The process of claim 27, wherein the light-activation is effected with UV irradiation.

47. The process of claim 46, wherein the UV radiation source is selected from the group consisting of xenon lamps, mercury lamps, black-light lamps, and excimer lamps.

48. The thick-walled molding product or coating produced by the process of claim 43.

49. The thick-walled molding product or coating of claim 48 further comprising spheres having a diameter of at least 1 mm.

50. A high-tension insulator or formed-in-place gasket comprising the thick-walled molding product of claim 48.

51. A conformal coating comprising the thick-walled coating of claim 48.

52. The thick-walled molding product or coating of claim 48 having a light transmittance of less than 10%, measured at 10 mm thickness.
